(19) United States
(12) Patent Application Publication
(10) Pub. No.: US 2016/0371904 A1
(43) Pub. Date: Dec. 22, 2016

(54) SECURITY DEVICE WITH OFFLINE CREDENTIAL ANALYSIS

(71) Applicant: UTC FIRE & SECURITY AMERICAS CORPORATION, INC., Bradenton, FL (US)

(72) Inventor: Anshuman SINHA, Boca Raton, FL (US)

(21) Appl. No.: 15/160,292

(22) Filed: May 20, 2016

Related U.S. Application Data
(63) Continuation of application No. 12/848,468, filed on Aug. 2, 2010, now abandoned.

(51) Int. Cl. G07C 9/00

(52) U.S. Cl. CPC G07C 9/00111

(57) ABSTRACT

An exemplary security system includes a credential holder having a credential database that contains specified secured area credential information indicating at least one secured access location between a specified secured area and a specified adjacent area where the credential information is valid for authorized access. An access control device at a selected position corresponding to the secured access location is configured to receive the credential information when the credential holder is near the access control device. A processor of the access control device has stored access control information including indications of the specified secured area, the specified adjacent area and the secured access location. The processor autonomously determines that access to the specified secured area will be granted when the received credential information corresponds to the stored indications.

### CROSS REFERENCE TO RELATED APPLICATION

This application is a continuation of U.S. patent application Ser. No. 12/848,468, filed on Aug. 2, 2010.

### BACKGROUND

There are a variety of security systems. Some are useful to control access to secured areas, for example. A typical system for access control includes requiring an individual that desires access to the secured area to present valid credential information that can be used to verify that the individual is authorized to have the desired access. A security guard may check a photo identification card and observe whether the individual is the person pictured on the card, for example.

Automated systems allow for a computer to make such a determination based on one or more signals received from a smart card, badge, phone or electronic key, for example. In most automated systems, a reader is positioned at the location where the individual desires access to the secured area. The reader obtains information from the card or key and communicates that to a remotely located controller that is in another location within the same building or in another building connected with wires or on a network, for example. The controller makes a determination whether the individual should be granted the desired access based on the information obtained by the reader and the access control permissions granted to the holder. The controller then causes the corresponding access control device (such as an automated lock) to allow the desired access or the controller determines that the desired access should be denied.

Such automated security systems have proven useful for a variety of situations. One drawback associated with such systems, however, is that they typically require hardwired connections between a plurality of dispersed readers and the controller. This introduces material and labor cost into such a security system. Additional costs include maintaining the network, which is required to distribute the database to the controller from a host. The network updates the databases should there be any change. Such systems are expensive and maintenance and installation costs are high.

### SUMMARY

An exemplary security system includes a credential holder having a credential database that contains specified secured area credential information indicating at least one secured access location between a specified secured area and a specified adjacent area where the credential information is valid for authorized access. An access control device at a selected position corresponding to the secured access location is configured to receive the credential information when the credential holder is near the access control device. A processor of the access control device has stored access control information including indications of the specified secured area, the specified adjacent area and the secured access location. The processor autonomously determines that access to the specified secured area will be granted when the received credential information corresponds to the stored indications.

An exemplary method of controlling access to a secured area includes providing a credential holder with a credential database that contains specified secured area credential information indicating at least one secured access location between a specified secured area and a specified adjacent area where the credential information is valid for authorized access. The credential information from the credential holder is received at an access control device at a selected position corresponding to the secured access location. The access control device determines whether to grant access to the specified secured area based on whether the received credential information corresponds to stored access control information at the access control device. The stored access control information of the access control device includes indications of the specified secured area, the specified adjacent area and the secured access location.

The various features and advantages of disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates a system for controlling access to a secured area designed according to an embodiment of this invention.

FIG. 2 schematically illustrates selected portions of the example of FIG. 1.

FIG. 3 is a flowchart diagram summarizing an example access control approach.

### DETAILED DESCRIPTION

A disclosed example embodiment includes an offline access control device that autonomously determines whether to grant access to a secured area without requiring the access control device to communicate with a remotely located security system server or to maintain a database of all authorized users. Instead, the disclosed example includes information stored by the access control device regarding a secured access location between the secured area and an adjacent area. A credential holder provides credential information that specifies which secured access locations between specified secured areas and specified adjacent areas are authorized. The access control device determines whether to grant access to the specified secured area based on whether there is sufficient correspondence between the credential information received from the credential holder and the stored information maintained by the access control device.

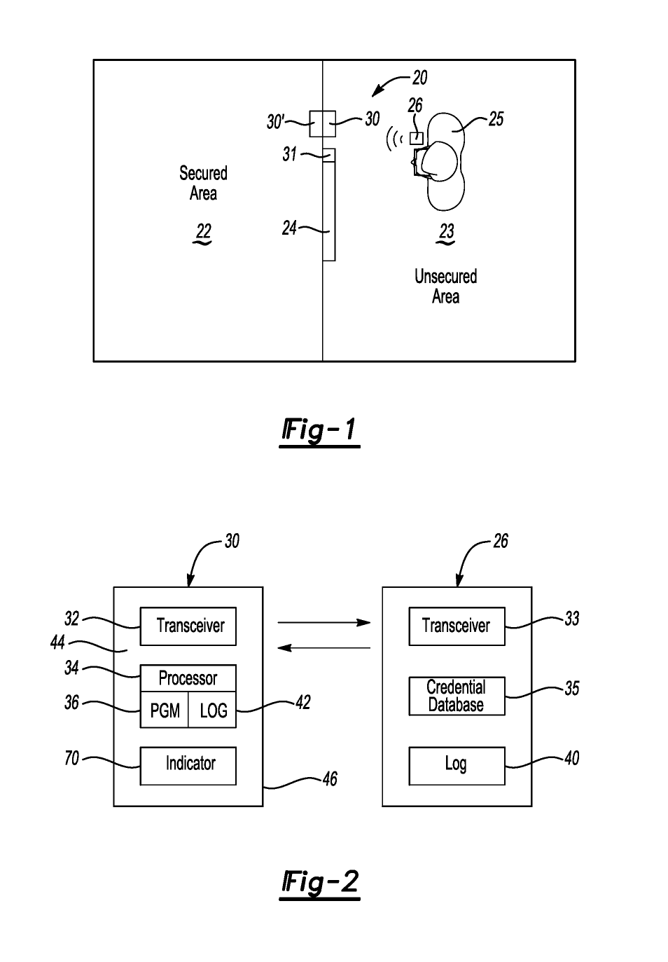

FIG. 1 schematically shows a security system 20 for controlling access to a secured area 22. In this example, the secured area 22 is separated from an unsecured area 23 by a secured access location 24, which is a door in one example. An example secured area may be physical such as a cabinet, a safe, a vault, a room or a building into which only authorized individuals are permitted to enter. The secured area in one example includes one or more areas served by an elevator. Although the area 23 is an unsecured area in this example, the adjacent area 23 also may be a secured area. For purposes of discussion, the area is referred to as an unsecured area.

An individual 25 desires access into the secured area 22. A credential holder 26 communicates with an access control device 30. The illustrated example includes wireless communication between the credential holder 26 and the access control device 30. The access control device 30 controls operation of another device 31 in the illustrated example such as a lock to provide control over whether access is granted to the secured area 22.

The credential holder 26 may be a smart card, a cell phone, an electronic key, an electronic badge or another device that is capable of providing at least one signal to the access control device 30 for communicating credential information to the access control device 30. The credential holder may also provide the credential information in another form distinct from a wirelessly transmitted signal.

The example credential holder 26 includes specified secured area credential information in a database 35 that comprises a list of secured areas that are available for authorized access. In this example, the credential information includes an indication of which secured access locations 24 between specified secured areas 22 and specified unsecured areas 23 are legitimate access locations through which the individual 25 is authorized to access the corresponding secured areas 22.

In some examples, the credential information includes additional data such as an issuance date and an expiration date (if applicable). For systems that require an individual to manually enter a personal identification number (PIN) when requesting access, the PIN will be stored on the credential holder 26 so that the access control device 30 can obtain the PIN from the credential holder 26 and compare that to the one entered by the individual 25.

One example system 20 requires that each credential holder 26 have an identifier that distinguishes that particular credential holder from at least some others. Some examples may have groups or sets of credential holders 26 with the same identifier. Other examples have a unique identifier for each individual credential holder 26. The security device obtains the identifier from the credential holder as part of the credential information used to make access grant decisions.

In one example, the credential holder 26 includes additional credential information such as the name of the individual assigned to that card, key or other communication device and a unique identifier (e.g., an employee number) assigned to that individual. Other personal details such as employee type or business responsibilities may also be stored on the credential holder 26. For purposes of making determinations regarding requested access the personal detail information may not be necessary and in some examples, it is excluded. One feature of the example access control device 30 is that it makes a determination based at least in part on the location at which the security device is located, which corresponds to the point at which the requested access to the secured area 22 is desired.

In examples that include personal detail information as part of the credential information, the credential holder 26 may be used with other security devices that are different than the access control device 30. For example, the same credential holder 26 may be used as described in connection with the illustrated example and with a conventional card reader that communicates with a central processor that determines if the personal information on the credential holder 26 allows for requested access to be granted as controlled by such a conventional card reader.

FIG. 2 schematically shows selected portions of an example access control device 30 and an example credential holder 26. The access control device 30 includes a transceiver 32 that is configured to receive at least one signal from a transceiver 33 of the credential holder 26. Transceivers 32 and 33 are schematically illustrated for simplicity but those skilled in the art will realize that individual transmitters and receivers could also be included as part of the access control device 30, the credential holder 26 or both. The form of the components utilized to realize communications between the access control device 30 and the credential holder 26 can be selected from among known technologies by those skilled in the art who have the benefit of this description.

The access control device 30 includes a processor 34 that autonomously determines whether the credential information received from the credential holder 26 indicates authorization for access to the secured area 22. The processor 34 in this example includes programming 36 that allows the processor 34 to autonomously determine whether the desired access will be granted without having to communicate with a remotely located controller. The programming 36 includes a set of rules that have to be satisfied for the received credential information to be considered valid. The processor 34 does not require any access to a network or controller database to make determinations according to the rules or criteria defined by the programming 36. In this example, the decision whether to grant access is made independent of any identification of the individual 25 and, instead, is based on whether the received credential information corresponds to stored information indicating the secured access location 24 between the secured area 22 and the unsecured area 23.

Stored access control information associated with the programming 36 indicates where the access control device 30 is installed and can be used to verify corresponding credential information from the credential holder 26. The access control device 30 in this example includes information regarding the secured access location 24, the secured area 22 and the unsecured area 23 as the stored access control information. In the illustrated example, the facility in which the security system 20 is used is divided into different areas with some being known as “secured areas” and requested access is granted or denied on the basis of secured area mapping. In this example each access control device 30 has a specified or defined secured area 22 and an adjacent unsecured area 23 on opposite sides of the secured access location 24 controlled by the access control device 30. The adjacent area also may be another secured area. Information corresponding to an identification of the particular access location between the particular secured and unsecured areas is stored on each access control device 30 and is used by each access control device 30 when determining whether presented credential information is valid.

The access control device 30 in this example includes an identifier that uniquely identifies the access control device 30. The identifier may be burned into firmware associated with the processor 34, for example, or otherwise written to the device 30. The identifier of the access control device 30 is used as an identifier of the secured access location over which the access control device 30 has control.

The processor 34 has access to a date and time indication, which can be updated by an internal clock or otherwise by the programming 36. Date and time information allows for controlling access according to authorized scheduling, for example.

The processor 34 causes the desired access to be granted when the received credential information sufficiently corresponds to the stored information associated with the programming 36. One example requires an exact match between an identifier of the secured access location 24, the specified secured area 22 and the specified unsecured area 23 on the one hand and the corresponding stored information of the processor 34 on the other hand before access to the secured area 22 will be granted. The processor 34 will provide an indication or control the operation of the device 31 (such as a lock or an automated door mover, for example) so that the individual 25 is able to enter the secured area 22 through the secured access location 24 from the unsecured area 23.

The illustrated example access control device 30 also provides data updates to the credential holder 26 by transmitting signals from the transceiver 32 to the transceiver 33, for example, when that is appropriate. In one example, the transceiver 32 is controlled by the processor 34 to provide data updates to the credential holder 26. The credential holder 26 in FIG. 2 stores transaction data updates from the access control device 30 at least temporarily in a log 40 so that the transaction data can be used for subsequent determinations regarding secured access for the individual 25. Some data updates received by the credential holder 26 from the access control device 30 will be stored in the credential database 35.

The autonomous functionality of the processor 34 does not include accessing a remote database to determine any history of the use of the credential holder 26, for example. Writing data to the credential holder 26 regarding a transaction with the access control device 30 allows the processor 34 to make subsequent access determinations based on subsequently retrieving an indication of such data from the credential holder. This particular approach allows the processor 34 to make such determinations autonomously without having to access a remotely stored network database, for example. Writing data updates to the credential holder 26 therefore simplifies the requirements for storage of information by the access control device 30 and facilitates using relatively simpler and less expensive components for the access control device 30 along with eliminating any wiring for connecting the access control device 30 to a network or controller.

The example access control device 30 of FIG. 2 also includes a log 42 for at least temporarily storing transaction information regarding interactions between the access control device 30 and the credential holder 26. It will be useful in some examples to maintain a selected (and typically limited) amount of transaction information on the log 42 to facilitate access determinations that require information that cannot be supplied by a single credential holder 26, for example. One such example includes a limited number of individuals being permitted in the secured area 22 at a particular time. The log 42 can be used to keep track of which credential holders or at least how many of them have been granted access within a selected time frame, for example. Other potential uses of the logs 41 and 42 are described below.

One feature of the example access control device 30 is that the transceiver 32 and the processor 34 are at least partially supported on a common mount 44, which comprises a circuit board in one example, so that they are all located together near the access location 24. The mount 44 facilitates securing the access control device 30 in a fixed location on a wall or other surface near a threshold or doorway into a secured area, for example. In this example the transceiver 32 and the processor 34 are contained within a single housing 46. This arrangement provides protection for the components of the access control device 30 and facilitates conveniently locating them all together at the same location.

Having the processor 34 that autonomously makes the determinations regarding granting access at the location where access is granted based on credential information stored by the credential holder 26 indicating the location where access is authorized is unique to the disclosed example. Previous systems required communication between a reader and a remotely located controller or other network components, for example, or required an extensive database of user identifiers being available to a reader.

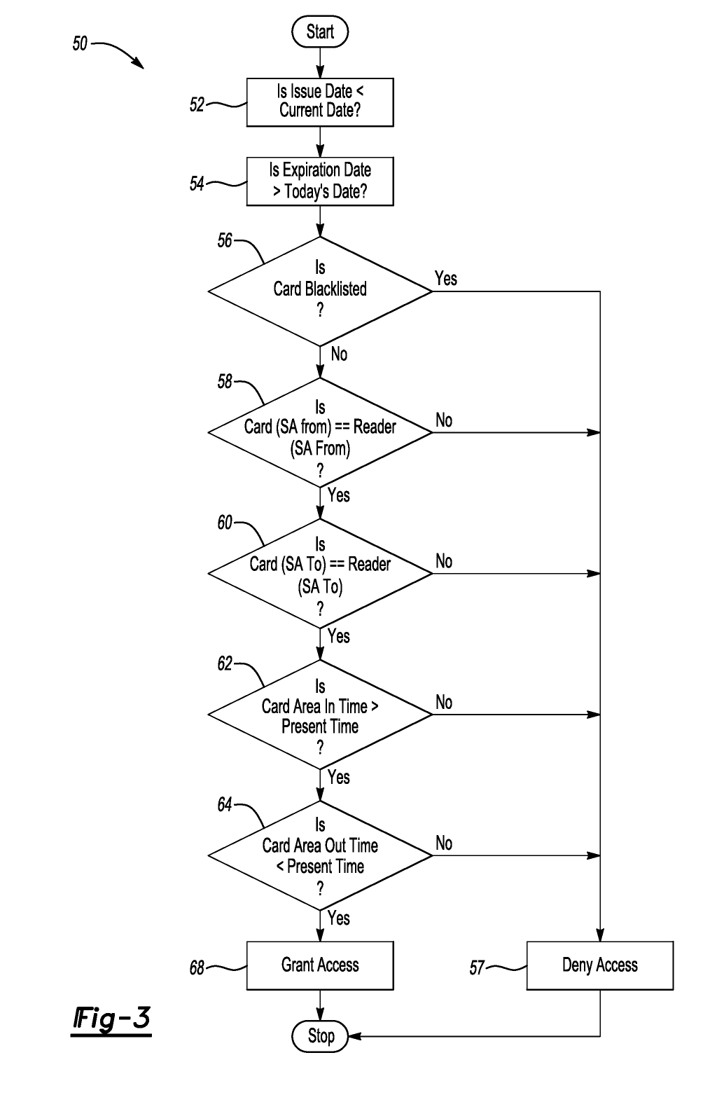

FIG. 3 includes a flow chart 50 that summarizes an example approach that an example access control device 30 uses to control access to the secured area 22. The credential holder 26 provides at least one signal to the access control device 30, which is an indication of specified secured area credential information stored in the database 35 of the credential holder 26. The credential holder 26 provides a wireless credential signal to the access control device 30 in the examples of FIGS. 1 and 2. Depending on the configuration of the credential holder 26, the credential signal may be responsive to an interrogation signal from the access control device 30, manually instigated by the individual 25 activating a switch on the credential holder 26 or be broadcast by the credential holder according to a selected schedule or pattern.

The processor 34 begins determining whether the credential information is valid at 52 where the processor 34 checks an issue date of the credential holder 26. The date of issue or activation of the credential holder 26 has to be before the current date in this example. At 54 another check on the credential holder 26 includes determining whether a preset expiration date has already passed.

Another determination is made at 56 regarding whether the credential holder 26 or the individual 25 has been placed on a restricted access list that indicates that the desired access should be denied. The credential holder 26 may contain such information because it was previously written to the credential holder 26 by an appropriately configured access control device, which may be different than the access control device 30, for example. One scenario in which an individual may be placed on a restricted access list is when an employee leaves a company and therefore should no longer be given access to secured areas. Another example scenario in which a credential holder 26 might be on a restricted list is when that particular credential holder 26 has been used to attempt to gain unauthorized access according to predetermined criteria, for example.

In the example of FIG. 3, when the information from the credential holder 26 indicates that the individual 25 is on a restricted access list that does not allow access to the secured area 22, the desired access is denied at 57.

The determinations at 52, 54 and 56 are optional in some examples.

Assuming that the credential holder 26 is legitimate and the individual 25 is not on a restricted access list, the next determination in this example is made at 58. The processor 34 determines whether the received credential information indicates that the credential holder is authorized for passage through the secured location 24 from the unsecured area 23. For example, only certain individuals may be allowed to enter the secured area 22 from the unsecured area 23. This feature is useful to control entry to an area, exit from an area or both. If the desired access is possible because the credential information indicates that access from the unsecured area 23 is authorized, another determination is made at 60. If that credential holder 26 cannot be used to gain access at that location 24, then access is denied at 57.

The access control device 30 is not associated with a remote controller or server that makes the determinations regarding credential acceptability. The credential holder 26 provides information indicating the point or points at which access for the individual 25 is authorized based on how the database 35 of the credential holder 26 was previously configured. The database 35 in some examples includes multiple secured access locations between different secured areas and unsecured areas. If at least one of those matches the one controlled by the access control device 30, then access can be granted. The processor 34 makes a determination whether the location of the access control device 30 corresponds to an authorized access location 24 included in the credential information received from the credential holder 26. In one example, the installation location of the access control device 30 is available to the processor 34 for such determinations but that information cannot be altered.

Given a positive conclusion at 58, the determination at 60 in this example includes determining whether the destination associated with the desired access is authorized. For example, the credential information must include an indication that access to the secured area 22 is authorized. In this example, the specified secured area of the credential information has to correspond to the secured area information maintained by the access control device identifying the secured area 22. In this example, the credential information indicates that the credential holder 26 (or the individual 25) is authorized to enter the secured area 22 from the unsecured area 23 through the access location 24. If the credential holder 26 provides an appropriate indication that allows the processor 34 to conclude that the individual can be granted access to the secured area 22 from the unsecured area 23, then the destination is authorized and further determinations are made at 62 and 64.

At this point in the illustrated example, the processor 34 determines whether there are any limits on the time during which the desired access is available based on the received credential information. For example, certain employees may be allowed into certain areas only during certain hours of the day. In this example, at 62 the processor 34 determines whether a current time of day (i.e., a time of the requested access) is after a starting time that defines a beginning of a window of time during which the desired access is authorized. If not, access is denied at 57. If the time of the request is after the starting time, then the processor 34 determines at 64 whether the current time is before the window of authorization expires. If not, then access is denied at 57.

In this example, if the determinations at 52, 54, 58, 60, 62 and 64 are all positive and the determination at 56 is negative, then access is granted at 68.

The access control device 30 is also capable of more complicated decision processes for controlling access to or from a secured area depending on the needs of a particular situation. For example, an anti-pass-back feature can be used to prevent an individual from passing the credential holder 26 to another individual before the access to the secured area 22 is closed after access has been granted. One such system includes two security devices 30 and 30′ that communicate with each other. One of the security devices controls entry to the secured area 22 and the other controls exit from that area 22. The “IN” reader 30 registers the entry of the credential holder 26 (i.e., the individual 25) in its log 42 and will not authorize entry for that credential holder again until after the “OUT” reader 30′provides an indication that the same credential holder 26 (or individual 25) has exited the secured area 22.

In another example, the access control device 30 will wait a certain prescribed time before allowing a credential holder 26 to be used after access has been granted. In one example, the time of access grant (or the time that the credential indication was received) is written to the log 40 of the credential holder 26 as a most recent time of granted access. The access control device 30 can use that information, the current time and the prescribed waiting time for determining whether a subsequent access request will be granted or denied.

In another example, an indication of the first access request (or grant) is buffered in the log 42 of the access control device 30 for at least a time corresponding to the prescribed time required between authorized access grants. The processor 34 uses that indication to determine whether it has been long enough since the latest grant based on a particular credential holder 26.

Another control feature includes limiting a number of times that an individual is allowed access to a particular secured area. Once the prescribed number of times has been reached, the credential holder 26 may be blacklisted, for example. The programming 36 in one example includes rules for placing a credential holder 26 on a restricted access list. An indicator of that may be written to the credential holder 26 by the access control device 30.

Offline readers such as the access control device 30 can also be used to control access to areas such as vaults by requiring a certain number of persons to have access at the same time or to require that a certain number of credential holders be presented before access will be granted.

It may be useful to monitor whether a security guard is patrolling a premises according to a prescribed schedule. The example access control device 30 facilitates this by writing a time when a credential holder assigned to the security guard is detected near the access control device 30. The guard can then use the credential holder 26 to provide such time information to an appropriate device that verifies the time or times when the guard completed the patrol.

For some of the more complex authorization schemes, it will be useful to store information in the log 40 of the credential holder 26, the log 42 of the access control device 30 or both. Some determinations will require information from both logs 40 and 42 while others may be made with information that is most logically stored in one of the logs.

One feature of the example access control device 30 of FIG. 2 is that it includes an indicator 70 that provides at least one of a visible or audible indication when the access control device 30 has been subjected to any attempted tampering, a credential holder 26 has been used inappropriately or a selected credential holder 26 has been detected near the access control device 30, for example. Information associated with the cause for the indication from the output 70 is stored in the log 42 in one example so that an authorized individual can obtain that information.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A security system, comprising:
a credential holder including a credential database that contains at least three items of credential information, the at least three items of credential information including
a specified secured area,
at least one secured access location, and
a specified adjacent area,
the credential information indicating the at lest one secured access location between the specified secured area and the specified adjacent area where the credential information is valid for authorized access;
an access control device at a selected position corresponding to the secured access location, the access control device being configured to receive the credential information when the credential holder is near the access control device, the access control device including a processor that has stored access control information that contains at least three items of access control information, the at least three items of access control information including:
the secured access location,
the specified secured area, and
the specified adjacent area,
the processor autonomously determining that access to the specified a secured area will be granted when the received credential information corresponds to the stored access control information.

2. The security system of claim 1, wherein
the processor determines whether to grant the desired access only if the received credential information indicates that access to the specified secured area from the adjacent area is authorized through the secured access point.

3. The security system of claim 1, wherein
the processor determines whether to grant access to the specified secured area independent of any indication of a user identity from the credential holder.

4. The security system of claim 1, wherein
the credential information includes an indication of a window of time during which access to the specified secured area is authorized; and
the processor determines whether to grant the access based on determining whether a current time is within the window of time.

5. The security system of claim 1, wherein
the credential information includes an indication of at least one of an issue date or an expiration date for the credential holder; and
the processor determines whether to grant the access based on determining at least one of (i) a relationship between the issue date and a current date or (ii) a relationship between the expiration date and the current date.

6. The security system of claim 1, wherein
the credential information includes an indication of whether the credential holder has been blacklisted; and
the processor determines whether to grant the access based on determining whether the provided credential information indicates that the credential holder has been blacklisted.

7. The security system of claim 1, wherein
the access control device comprises a transmitter that is configured to transmit at least one signal to the credential holder, the processor causing the transmitter to provide the credential holder with at least one transaction data update to be at least temporarily stored by the credential holder as part of the credential information associated with the secured access location.

8. The security system of claim 7, wherein
the processor causes the transmitter to provide the credential holder with transaction data including at least one of
an indication of the secured access location;
an indication of a time that the access was requested;
an indication of a time that the access was granted;
a number of times that the credential holder has been used to request the access; or
an indication that the access was denied by the processor; and
the credential holder at least temporarily stores the transaction data in association with the credential information corresponding to the secured access location.

9. The security system of claim 7, wherein
the processor causes the transmitter to provide the transaction data update to the credential holder associated with a first access request; and
the processor uses a subsequent receipt of the provided transaction data update from the credential holder for determining whether a second, subsequent access request will be granted.

10. The security system of claim 9, wherein
the processor determines whether the second access request corresponds to an unauthorized duplicate use of the credential holder at the secured access location.

11. The security system of claim 7, wherein
the credential holder subsequently provides the transaction data update to another device for indicating whether a guard tour has been completed.

12. A method of controlling access to a secured area, comprising the steps of:
providing a credential holder with a credential database that contains
at least three items of credential information, the at least three items of credential information including
a specified secured area,
at least one secured access location, and
a specified adjacent area,
the credential information indicating the at lest one secured access location between the specified secured area and the specified adjacent area where the credential information is valid for authorized access;
receiving the credential information from the credential holder at an access control device at a selected position corresponding to the secured access location;
using the access control device for determining whether to grant access to the specified secured area based on whether the received credential information corresponds to stored access control information at the access control device, the stored access control information contains at least three items of access control information, the at least three items of access control information including:
the secured access location,
the specified secured area, and
the specified adjacent area.

13. The method of claim 12, comprising
determining whether to grant the access only if the received credential information indicates that access to the specified secured area from the adjacent area is authorized through the secured access point.

14. The method of claim 12, comprising
determining whether to grant access to the specified secured area independent of any indication of a user identity from the credential holder.

15. The method of claim 12, wherein the credential information includes an
indication of a window of time during which access to the specified secured area is authorized; and
the method comprises determining whether to grant the access based on determining whether a current time is within the window of time.

16. The method of claim 12, wherein the credential information includes an indication of at least one of an issue date or an expiration date for the credential holder; and
the method comprises determining whether to grant the access based on determining at least one of (i) a relationship between the issue date and a current date or (ii) a relationship between the expiration date and the current date.

17. The method of claim 12, wherein the credential information includes an indication of whether the credential holder has been blacklisted; and
the method comprises determining whether to grant the access based on determining whether the provided credential information indicates that the credential holder has been blacklisted.

18. The method of claim 12, comprising
providing the credential holder with at least one transaction data update to be at least temporarily stored by the credential holder as part of the credential information associated with the secured access location.

19. The method of claim 18, comprising
providing the credential holder with transaction data including at least one of
an indication of the secured access location;
an indication of a time that the access was requested;
an indication of a time that the access was granted;
a number of times that the credential holder has been used to request the access; or
an indication that the access was denied by the processor; and
at least temporarily storing the transaction data by the credential holder in association with the credential information corresponding to the secured access location.

20. The method of claim 18, comprising
providing the transaction data update to the credential holder associated with a first access request; and
using a subsequent receipt of the provided transaction data update from the credential holder for determining whether a second, subsequent access request will be granted.

21. The method of claim 20, comprising
determining whether the second access request corresponds to an unauthorized duplicate use of the credential holder at the secured access location.

22. The method of claim 18, comprising
subsequently providing the transaction data update from the credential holder to another device for indicating whether a guard tour has been completed.
